(19) United States
(12) Patent Application Publication
(10) Pub. No.: US 2003/0057784 A1
(43) Pub. Date: Mar. 27, 2003

(54) Magnetically levitated motor and magnetic bearing apparatus

(76) Inventor: Hideki Kanebako, Nagano (JP)

Correspondence Address: HOGAN & HARTSON L.L.P., 500 S. GRAND AVENUE, SUITE 1900, LOS ANGELES, CA, 90071-2611, US

(21) Appl. No.: 10/253,576

(22) Filed: Sep. 24, 2002

(30) Foreign Application Priority Data
Sep. 26, 2001 (JP) 2001-293022

(51) Int. Cl. H02K 7/09

(52) U.S. Cl. 310/90.5

(57) ABSTRACT

A magnetically levitating motor includes a rotor that is formed from a magnetic material and has a permanent magnet attached along a circumference thereof, and a stator core section having a first stator coil that generates a levitation control magnetic flux that controls levitation of the rotor in a radial direction and a second coil that generates rotational magnetic flux against the rotor. In one aspect of the present invention, a rotor side thrust bearing magnetic path section is formed on the rotor, and a stator side thrust bearing magnetic path section that is disposed opposite in the radial direction to the rotor side thrust bearing magnetic path section is provided on the stator. A bias magnetic flux that forms the radial levitation control magnetic flux is formed to pass a gap in the radial direction between the rotor side thrust bearing magnetic path section and the stator side thrust bearing magnetic path section. A thrust control coil that generates a supporting force to support the thrust bearing load is disposed in the bias magnetic flux that forms the radial levitation control magnetic flux, wherein the thrust control coil is wound about a rotational axis with respect to one of the rotor side thrust bearing magnetic path section and the stator side thrust bearing magnetic path section.

### BACKGROUND OF THE INVENTION

1. Field of the Invention

The present invention relates to a magnetically levitated motor and magnetic bearing apparatus equipped with a radial magnetic bearing and a thrust magnetic bearing that levitates and controls a rotor.

2. Description of Related Art

Bearing apparatuses that are widely used in various equipment include, in addition to common contact type bearing apparatuses, magnetic bearing apparatuses that use magnetic force to levitate a rotary body such as a rotor shaft, and supports the rotary body in a non-contact matter. With a magnetic bearing apparatus, the coefficient of friction at its bearing sections is nearly zero, and thus a high speed rotation of the rotary body becomes possible. Also, since magnetic bearing apparatuses do not require lubricating oil, they can be used in special environments such as at high temperatures, lower temperatures or in vacuum, and are advantageous in that no maintenance is required.

In view of the advantages described above, it is proposed that a magnetic bearing apparatus be used to support a rotor of a motor. The basic structure of a motor having a magnetic bearing apparatus is such that a magnetic bearing apparatus, a rotational force generation mechanism, i.e., a motor section, a magnetic bearing apparatus are in this order disposed along a direction of a rotational axis. However, such an arrangement would increase the axial length because the magnetic bearing apparatuses are disposed at both sides of the motor section, which result in drawbacks such as a lowered natural frequency and a lowered critical speed.

In view of the fact that a stator of a magnetic bearing apparatus and a stator or an AC motor have generally the same structure, magnetically levitating motors in which a magnetic bearing apparatus and a motor are integrated in one piece have been proposed. One type of the magnetically levitating motors is a hybrid type magnetically levitating motor, which uses permanent magnets to create a constant magnetic flux that radially extends from within the rotor, such that the levitation and control of the rotor can be conducted by a two-pole DC magnetic field in a similar manner as a common magnetic bearing apparatus. With this hybrid type magnetically levitating motor, the permanent magnets create a constant magnetic flux and thus a bias attraction force can be generated without consuming electrical power, such that its electrical magnet is only responsible for the controlling force.

Such a conventional hybrid type magnetically levitating motor is a hybrid of a radial magnetic bearing and a motor, and its thrust bearing has a structure in which a magnetic bearing that functions only as a magnetically levitating type thrust bearing is added to the motor. In the meantime, there have been proposed magnetic bearings with specially devised magnetic circuits which form a compound structure of a radial magnetic bearing and a thrust magnetic bearing.

As described above, a conventional magnetically levitating motor that integrates a magnetic bearing and a motor in one piece is a combination of a radial magnetic bearing and a motor, and its thrust bearing is of a type in which a thrust magnetic bearing that independently functions as a thrust bearing is merely added to the motor. The thrust magnetic bearing occupies a large portion against the overall size of the motor, which would prevent a further reduction in the size of magnetically levitating motors. Also, when a magnetic bearing that forms a compound structure of a radial magnetic bearing and a thrust magnetic bearing, a motor is independently required. This would also prevent a further reduction in the size of magnetically levitating motors.

The inventor of the present application has proposed a structure in which a hybrid type radial magnetically levitating motor and a thrust magnetic bearing are integrated into one piece in terms of magnetic circuit, such that the bias magnetic flux of the thrust magnetic bearing can be shared by the hybrid type radial magnetically levitating motor. However, this structure has a drawback in that the negative magnetic spring property in the thrust direction tends to become larger as the bias magnetic flux becomes larger, and the control of the thrust magnetic bearing becomes unstable.

### SUMMARY OF THE INVENTION

The present invention has been made to solve the problems described above, and the present invention provides a magnetically levitating motor and a magnetic bearing apparatus in which a bias magnetic flux of a hybrid type magnetically levitating motor or a magnetic bearing apparatus is formed and a thrust bearing is disposed in a magnetic path of the bias magnetic flux, whereby the magnetically levitating motor and the thrust magnetic bearing form a compound structure that is small in size, and perform a stable bearing support control in the thrust direction.

The present invention also relates to a magnetically levitating motor and a magnetic bearing apparatus which are capable of controlling the thrust bearing with a single coil by using a bias magnetic flux. Since the magnetically levitating motor or the magnetic bearing apparatus does not require a bias electric current, the power consumption thereof can be reduced.

In accordance with an embodiment of the present invention, a magnetically levitating motor includes a rotor that is formed from a magnetic material and has a permanent magnet attached along a circumference thereof, and a stator core section having a first stator coil that generates a levitation control magnetic flux that controls levitation of the rotor in a radial direction and a second coil that generates rotational magnetic flux against the rotor. In one aspect of the present invention, a rotor side thrust bearing magnetic path section is formed on the rotor, and a stator side thrust bearing magnetic path section that is disposed opposite in the radial direction to the rotor side thrust bearing magnetic path section is provided on the stator; a bias magnetic flux that forms the radial levitation control magnetic flux is formed to pass a gap formed in the radial direction between the rotor side thrust bearing magnetic path section and the stator side thrust bearing magnetic path section; a thrust control coil that generates a supporting force to support the thrust bearing load is disposed in the bias magnetic flux that forms the radial levitation control magnetic flux; and the thrust control coil is wound about a rotational axis with respect to one of the rotor side thrust bearing magnetic path section and the stator side thrust bearing magnetic path section.

With the magnetically levitating motor having the structure described above, a thrust magnetic bearing equipped with a favorable thrust bearing characteristic in a voice coil motor (VCM) system in which a coil is turned about the rotational axis is formed into a compound structure with a magnetically levitating motor that has a compound structure of a radial magnetic bearing and a motor.

In the magnetically levitating motor described above, the rotor side thrust bearing magnetic path section and the stator side thrust bearing magnetic path section may be formed from generally cylindrical members about the rotational axis as a center, and the thrust control coil is wound along an external circumferential surface of one of the generally cylindrical members. As a result, the thrust control coil can be contained in a small space.

Furthermore, in the magnetically levitating motor described above, the thrust control coil may be short-circuited. As a result, a damper effect in the thrust direction against vibrations in the thrust direction can be obtained without consuming the electrical power.

Moreover, in the magnetically levitating motor described above, two stator core sections may be disposed adjacent to each other along the axial direction, and a radial direction opposing section between the rotor side thrust bearing magnetic path section and the stator side thrust bearing magnetic path section may be disposed between the two stator core sections. This structure provides in effect two motor sections, in which the thrust loads of the two motor sections are supported by the single thrust magnetic bearing. As a result, a relatively compact magnetically levitating motor that provides a large output can be achieved despite the fact that the motor has the thrust magnetic bearing.

Furthermore, in the magnetically levitating motor described above, the stator core section and the stator side thrust bearing magnetic path section may be disposed adjacent to one another in the axial direction. As a result, a greater controlling force in the thrust direction is obtained and thus the control in the thrust direction can be conducted quickly and stably.

Moreover, in another aspect of the present invention, the rotor may be an outer rotor type or an inner rotor type. A bias magnet that generates the bias magnetic flux may be provided on the side of the rotor, and a ring-shaped rotor magnet that generates a rotational torque may be provided on the side of the rotor and opposite to the stator core section. Alternatively, a bias magnet that generates the bias magnetic flux may be provided on the side of the stator, and a ring-shaped rotor magnet that generates a rotational torque may be provided on the side of the rotor opposite to the stator core section.

In accordance with another embodiment of the present invention, a magnetic bearing apparatus includes a rotor that is formed from a magnetic material and has a permanent magnet attached along a circumference thereof, and a stator core section having a stator coil that generates a radial levitation control magnetic flux that controls levitation of the rotor in a radial direction. In one aspect of the present invention, a rotor side thrust bearing magnetic path section is formed on the rotor, and a stator side thrust bearing magnetic path section that is disposed opposite in the radial direction to the rotor side thrust bearing magnetic path section is provided on the stator; a bias magnetic flux that forms the radial levitation control magnetic flux is formed to pass a gap formed in the radial direction between the rotor side thrust bearing magnetic path section and the stator side thrust bearing magnetic path section; a thrust control coil that generates a supporting force to support the thrust bearing load is disposed in the bias magnetic flux that forms the radial levitation control magnetic flux; and the thrust control coil is wound about a rotational axis with respect to one of the rotor side thrust bearing magnetic path section and the stator side thrust bearing magnetic path section.

With the magnetic bearing apparatus having the structure described above, a thrust magnetic bearing equipped with a favorable thrust bearing characteristic created by a voice coil motor (VCM) system in which a coil is wound about the rotational axis is formed into a compound structure with a radial magnetic bearing.

Also, in the magnetic bearing apparatus described above, the rotor side thrust bearing magnetic path section and the stator side thrust bearing magnetic path section may be formed from generally cylindrical members about the rotational axis as a center, and the thrust control coil is wound along an external circumferential surface of one of the generally cylindrical members. As a result, the thrust control coil can be contained in a small space.

Furthermore, in the magnetic bearing apparatus described above, the thrust control coil may be short-circuited. As a result, a damper effect in the thrust direction against vibrations in the thrust direction can be obtained without consuming the electrical power.

Furthermore, in the magnetic bearing apparatus described above, the stator core section and the stator side thrust bearing magnetic path section may be disposed adjacent to one another in the axial direction. As a result, a greater controlling force in the thrust direction is obtained and thus the control in the thrust direction can be conducted quickly and stably.

Moreover, in the magnetic bearing apparatus described above, the rotor may be an outer rotor type or an inner rotor type. A bias magnet that generates the bias magnetic flux may be provided on the side of the rotor. Alternatively, a bias magnet that generates the bias magnetic flux may be provided on the side of the stator.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 shows a longitudinal cross section of a magnetically levitating motor in accordance with an embodiment of the present invention.

FIG. 2 shows a longitudinal cross section of a magnetically levitating motor in accordance with another embodiment of the present invention.

FIG. 3 shows a longitudinal cross section of a magnetic bearing apparatus in accordance with an embodiment of the present invention.

### DESCRIPTION OF PREFERRED EMBODIMENTS

A magnetically levitating motor in accordance with an embodiment of the present invention will be described below with reference to the accompanying drawings.

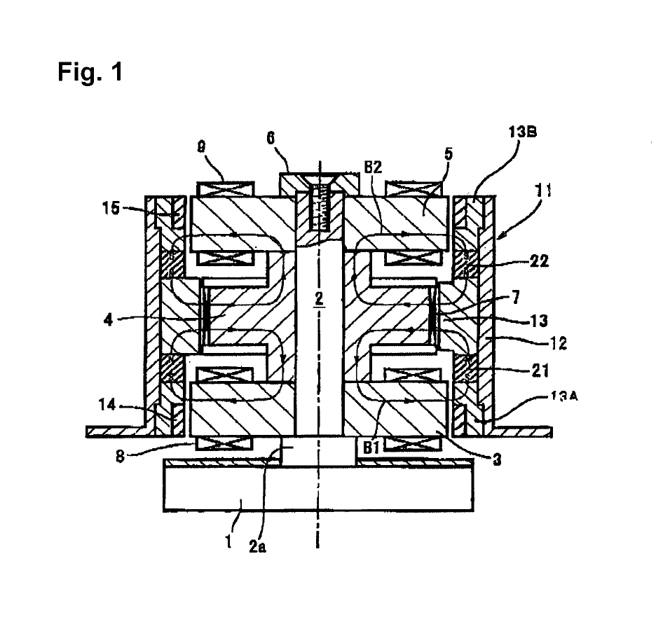

Referring to FIG. 1, a fixed shaft 2 extends upwardly in the figure from a base frame 1, wherein the fixed shaft 2 and the base frame 1 may be formed in one piece. The fixed shaft 2 passes through a first stator core 3, a stator yoke 4 and a second stator core 5 that are successively arranged along an axial direction of the fixed shaft 2. The first stator core 3 abuts in the axial direction against a stepped section 2a provided at a lower section (in the figure) of the fixed shaft 2 and is thus positioned with respect to the fixed shaft 2. A clamp member 6 is screw-fastened to an upper end section in the figure of the fixed shaft 2, thereby pressing the second stator core 5 in the axial direction, such that the first stator core 3, stator yoke 4 and second stator core 5 are affixed to the fixed shaft 2.

The stator yoke 4 composes a stator side thrust bearing magnetic path section that is formed from a generally cylindrical member. A thrust control coil 7 is wound along an external circumferential section of the stator yoke 4 that is in a coil bobbin shape through an insulation material about an axis of the fixed shaft 2. Also, a stator coil 8 and a stator coil 9 are wound on the respective first and second stator cores 3 and 5. Each of the stator coils 8 and 9 is composed of a first stator coil that generates a two-pole levitation control magnetic flux for controlling the levitation of a rotor 11 to be described in a greater detail below in the radial direction, and a second stator coil that generates a rotary magnetic filed against the rotor 11.

The rotor 11 is rotatably supported with respect to the fixed shaft on an outer circumferential surface of a stator that is formed from the first and second stator cores 3 and 5 and the stator yoke 4.

The rotor 11 is formed with a rotor sleeve 12 as a main component that is composed of a cylindrical magnetic member. The rotor sleeve 12 is disposed in a manner to circularly encircle the stator. A flange-shaped yoke 13 protrudes inwardly from an inner wall surface of the rotor sleeve 12 generally at a central portion of the rotor sleeve 12 in the axial direction. The flange-shaped yoke 13 that forms a rotor side thrust bearing magnetic path section may be integrally formed with the rotor sleeve 12. An inner circumferential end face of the flange-shaped yoke 13 is disposed facing inwardly in a radial direction opposite and in proximity to the thrust control coil 7 that is wound on the stator yoke 4 described above.

A first rotor magnet 14 and a second rotor magnet 15, which are each formed from a ring-shaped permanent magnet, are fixed through a first rotor yoke 13A and a second rotor yoke 13B, respectively, at both ends (an upper end and a lower end) in the axial direction on the inner circumferential wall surface of the rotor sleeve 12. The first and second rotor magnets 14 and 15 are disposed in proximity in the radial direction to external circumferential end surfaces of the first and second stator cores 3 and 5, respectively.

A first bias magnet 21 and a second bias magnet 22 are disposed at sections on both sides in the axial direction of the flange-shaped yoke 13 in the rotor sleeve 12 described above. Each of the bias magnets 21 and 22 is formed in a ring-shape, and magnetized in the axial direction. Therefore, with the first bias magnet 21, a bias magnetic flux B1 that successively passes through the first bias magnet 21—the flange-shaped yoke 13—the thrust control coil 7—the stator yoke 4—the first stator core 3—the first rotor yoke 13A—the first bias magnet 21. Also, with the second bias magnet 22, a bias magnetic flux B2 that successively passes through the second bias magnet 22—the flange-shaped yoke 13—the thrust control coil 7—the stator yoke 4—the second stator core 5—the second rotor yoke 13B—the second bias magnet 22.

Magnetic paths of the bias magnetic fluxes B1 and B2 are those for thrust bearings; and each of the magnetic paths can be divided into a stator side thrust bearing magnetic path and a rotor side thrust bearing magnetic path. A gap is formed in the radial direction between the flange-shaped yoke 13 on the rotor sleeve 12 side and the thrust control coil 7 provided on the stator yoke 4 on the stator side, and both of the bias magnetic fluxes B1 and B2 are arranged to pass the gap in the radial direction.

In other words, the thrust control coil 7 forms a thrust bearing apparatus of a voice coil motor (VCM) system. As a current is circulated through the thrust control coil 7, Lorenz force is generated in the thrust control coil 7 against the bias magnetic fluxes B1 and B2 that traverse the thrust control coil 7. By controlling the current to the thrust control coil 7, the reaction force caused by the Lorenz force is controlled and thus the position of the rotor 11 in its axial direction is controlled. In one embodiment, a sensor (not shown in the drawings) may be provided to detect the position of the rotor 11 in the axial direction. When the rotor 11 shifts its position in one direction in the axial direction, the sensor detects such movement and provides an output based on the detection. A current may be circulated in the thrust control coil 7 in forward or reverse direction and the current amount is controlled based on the output from the sensor to thereby control the position of the rotor 11 in the axial direction (i.e., the position of the rotor 11 in the thrust direction) so that the rotor 11 stays at a predetermined position.

In the mean time, the first stator core 3, the second stator core 5, the stator coils 8 and 9, and the first rotor magnet 14 and the second rotor magnet 15 form a compound structure of a radial magnetic bearing and a motor. More specifically, each of the stator coils 8 and 9 is composed of a first stator coil and a second stator coil, and a sensor (not shown in the drawings) detects the position of the rotor 11 in its radial direction. When the rotor 11 shifts its position in one direction in the radial direction, a current to the first stator coil is controlled based on an output from the sensor. Mutual actions between the bias magnetic fluxes B1 and B2 and the two-pole radial levitation control flux generated from the first stator coil controllably levitate the rotor in the radial direction, keeps the rotor 11 at a predetermined position in its radial direction and supports the rotor 11 in a non-contact manner in the radial direction.

Also, by controlling a current to the second stator coil, a rotary magnetic field is generated against the rotor 11. By mutual actions between the rotary magnetic field and the rotor magnets 14 and 15, the rotor 11 is rotatably driven.

As described above, in the first embodiment shown in FIG. 1, a magnetically levitating motor that is formed from a compound structure of a radial magnetic bearing and a motor is provided with a rotor side thrust bearing magnetic path section and a stator side thrust bearing magnetic path section disposed opposite in the radial direction to the rotor side thrust bearing magnetic path section. Bias magnetic fluxes B1 and B2, which form radial levitation control fluxes, are arranged to pass the thrust control coil 7 in a voice coil motor (VMC) system disposed between the rotor side thrust bearing magnetic path section and the stator side thrust bearing magnetic path section. With the structure described above, and by circulating a current through the thrust control coil 7, the thrust bearing load is supported. Therefore, the thrust magnetic bearing can also be formed into a compound structure with the magnetically levitating motor that has a compound structure of a radial magnetic bearing and a motor. As a result, the motor can be reduced in size, and its axial length can be shortened. Moreover, higher revolution speeds can be obtained, and favorable thrust bearing characteristics by the voice coil motor (VCM) system can be obtained.

Also, in accordance with the embodiment described above, the first stator core 3 and the second stator core 5 are disposed next to each other in the axial direction, and a gap in the radial direction between the rotor side thrust bearing magnetic path section and the stator side thrust bearing magnetic path section is formed between the first stator core 3 and the second stator core 5. This provides in effect two motor sections, and provides a structure in which thrust loads of the two motor sections are supported by a single thrust magnetic bearing. As a result, a compact magnetically levitating motor that provides a greater output can be obtained in spite of the fact that it has a thrust magnetic bearing.

Moreover, the first stator core 3, the second stator core 5 and the stator side thrust bearing magnetic path section are arranged in the axial direction. As a result, a greater controlling force in the thrust direction is obtained, and the control of movements of the rotor 11 in the thrust direction can be quickly and stably conducted.

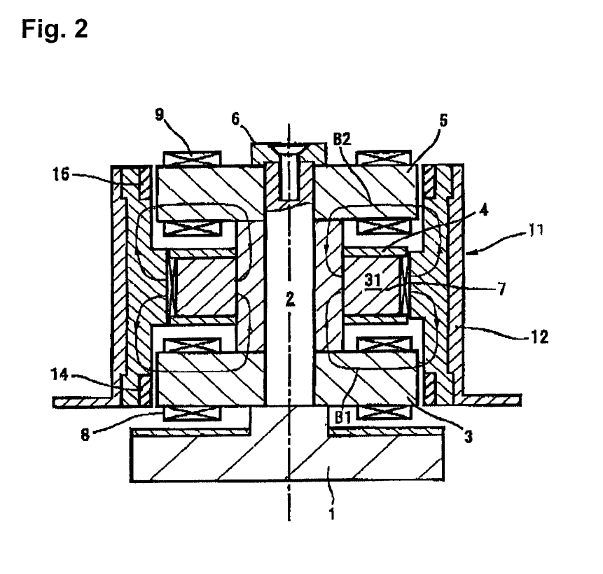

In accordance with a second embodiment of the present invention shown in FIG. 2, a bias magnet 31 that forms bias magnetic fluxes B1 and B2 is disposed within the stator yoke 4 on the stator side. This embodiment can provide effects and functions similar to those of the embodiment described above.

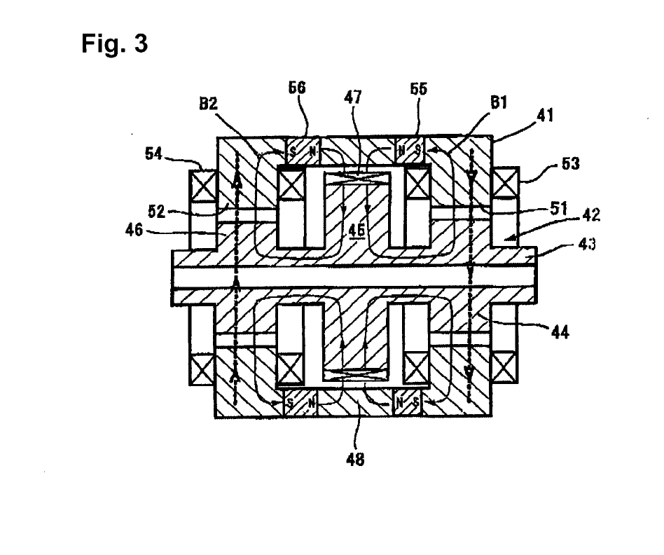

FIG. 3 shows a hybrid type magnetic bearing apparatus in which the present invention is applied.

As indicated in FIG. 3, a rotor 42 is rotatably supported on the inside of a stator core 41 that is in a generally cylindrical form. The rotor 42 has a rotary shaft 43. A first rotor yoke 44, a center rotor yoke 45 and a second rotor yoke 46 are successively disposed along the rotary shaft 43 in the axial direction. The center rotor yoke 45 is formed from a generally cylindrical member in a coil bobbin shape, which forms a rotor side thrust bearing magnetic path section. A thrust control coil 47, which is wound about the rotary shaft as a center, is disposed on an outer circumferential section of the center rotor yoke 45.

The stator core 41 is disposed on the outer circumferential side of the rotor 42 that is structured including the first and second rotor yokes 44 and 46 and the center rotor yoke 45. The stator core 41 is formed from a core rib 48 as a main member that forms a stator side thrust bearing magnetic path section that is formed from a generally cylindrical magnetic material. The core rib 48 is disposed in a manner to encircle the rotor 42. A first core salient pole 51 and a second core salient pole 52 are formed in one piece with the core rib 48. The first core salient pole 51 and the second core salient pole 52 are provided at both end sections of the core rib 48 on its inner circumferential side in the axial direction in a manner that the first core salient pole 51 and a second core salient pole 52 protrude inwardly toward the center. Inner circumferential end faces of the respective first and second core salient poles 51 and 52 are disposed facing inwardly in a radial direction opposite and in proximity to the first and second rotor yokes 44 and 46, respectively.

Stator coils 53 and 54 are wound on the first and second core salient poles 51 and 52, respectively. Each of the stator coils 53 and 54 is formed from a coil that is wound in a manner to generate a two-pole levitation control magnetic flux for controlling the levitation of the rotor 42 in the radial direction.

Also, a first bias magnet 55 and a second bias magnet 56, which are separated a predetermined distance in the axial direction from each other, are disposed in the core rib 48. Each of the bias magnets 55 and 56 is formed in a ring shape and magnetized in the axial direction. Therefore, a bias magnetic flux B1, which successively passes through the first bias magnet 55—the core rib 48—the thrust control coil 47—the center rotor yoke 45—the first rotor yoke 44—the first core salient pole 51—the core rib 48—the first bias magnet 55, is formed. Also, a bias magnetic flux B2, which successively passes through the second bias magnet 56—the core rib 48—the thrust control coil 47—the center rotor yoke 45—the second rotor yoke 46—the second core salient pole 52—the core rib 48—the second bias magnet 56, is formed.

Magnetic paths of the bias magnetic fluxes B1 and B2 are those for thrust bearings; and each of the magnetic paths can be divided into a stator side thrust bearing magnetic path and a rotor side thrust bearing magnetic path. A gap is formed in the radial direction between the core rib 48 and the thrust control coil 47 provided at the center rotor yoke 45 on the side of the stator, and both of the bias magnetic fluxes B1 and B2 are arranged to pass the gap.

In other words, the thrust control coil 47 forms a thrust bearing apparatus of a voice coil motor (VCM) system. As a current is circulated through the thrust control coil 47, Lorenz force is generated in the thrust control coil 47 against the bias magnetic fluxes B1 and B2 that traverse the thrust control coil 47. By controlling the current to the thrust control coil 47, the reaction force caused by the Lorenz force is controlled and thus the position of the rotor 42 in its axial direction is controlled. In one embodiment, a sensor (not shown in the drawings) may be provided to detect the position of the rotor 42 in the axial direction. When the rotor 42 shifts its position in one direction in the axial direction, the sensor detects such movement and provides an output based on the detection. A current may be circulated in the thrust control coil 47 in forward or reverse direction and the current amount is controlled based on the output from the sensor to thereby control the position of the rotor 42 in the axial direction (i.e., the position of the rotor 42 in the thrust direction) so that the rotor 42 stays at a predetermined position.

In the mean time, the first and second core salient poles 51 and 52, and the first and second stator coils 53 and 54 form a radial magnetic bearing. More specifically, a sensor (not shown in the drawings) detects the position of the rotor 42 in its radial direction. When the rotor 42 shifts its position in one direction in the radial direction, a current to the first and second stator coils 53 and 54 is controlled based on an output from the sensor. Mutual actions between the bias magnetic fluxes B1 and B2 and the two-pole radial levitation control flux generated from the first stator coil controllably levitate the rotor 42 in the radial direction, keeps the rotor 42 at a predetermined position in its radial direction and supports the rotor 42 in a non-contact manner in the radial direction.

As described above, in the embodiment shown in FIG. 3, a magnetically levitating type radial magnetic bearing is provided with a rotor side thrust bearing magnetic path section and a stator side thrust bearing magnetic path section disposed opposite in the radial direction to the rotor side thrust bearing magnetic path section. Bias magnetic fluxes B1 and B2, which form radial levitation control fluxes, are arranged to pass the thrust control coil 47 in a voice coil motor (VMC) system disposed between the rotor side thrust bearing magnetic path section and the stator side thrust bearing magnetic path section. With the structure described above, and by circulating a current through the thrust control coil 47, the thrust bearing load is supported. Therefore, the thrust magnetic bearing can also be formed into a compound structure with the radial magnetic bearing. As a result, the axial length of the bearing apparatus can be shortened, and favorable thrust bearing characteristics by the voice coil motor (VCM) system can be obtained.

Although not shown in the drawings, a ring-shaped rotor magnet formed from permanent magnet may be affixed to the external circumferential surface of each of the first and second rotor yokes 44 and 46. As a result, the magnetic bearing apparatus shown in FIG. 3 can also used as an inner rotor type magnetically levitating motor.

Embodiments of the present invention have been described above. However, the present invention is not limited to the embodiments described above, and many modifications can be made without departing from the subject matter of the present invention.

For example, as in each of the embodiments described above, the present invention is applicable to both of the outer rotor type and the inner rotor type, and magnetic bearing apparatuses in accordance with the present invention can also be used as a variety of bearing apparatuses that are used in various apparatuses other than motors.

Also, the thrust control coil in a voice coil motor (VCM) system described in each of the above embodiments can be disposed short-circuited. By composing the thrust control coil in a short-circuited state, damper effects against vibrations in the thrust direction can be provided without consuming electrical power.

With the magnetically levitating motor having the structure described above, a thrust magnetic bearing equipped with a favorable thrust bearing characteristic in a voice coil motor (VCM) system in which a coil is turned about the rotational axis is formed into a compound structure with a magnetically levitating motor that has a compound structure of a radial magnetic bearing and a motor. As a result, the motor can be reduced in size and its axial length can be shortened. Moreover, higher revolution speeds can be obtained, and the control of movements in the bearing in the thrust direction can be stably conducted. As a result, highly practical magnetically levitating motors can be obtained.

In the magnetically levitating motor described above, the rotor side thrust bearing magnetic path section and the stator side thrust bearing magnetic path section may be formed from generally cylindrical members about the rotational axis as a center, and the thrust control coil is wound along an external circumferential surface of one of the generally cylindrical members. As a result, the thrust control coil can be contained in a small space, such that the apparatus can be further reduced in size.

Furthermore, in the magnetically levitating motor described above, the thrust control coil may be short-circuited. As a result, a damper effect in the thrust direction against vibrations in the thrust direction can be obtained without consuming the electrical power.

Also, in the magnetically levitating motor described above, the thrust control coil can be short-circuited to provide damper effects against vibrations in the thrust direction without consuming electrical power. Therefore, the power consumption can be further reduced.

Moreover, in the magnetically levitating motor described above, two stator core sections may be disposed adjacent to each other along the axial direction, and a rotor side thrust bearing magnetic path section and two stator side thrust bearing magnetic path sections may be formed between the two stator core sections. This provides in effect two motor sections, and provides a structure in which the thrust loads of the two motor sections are supported by the single thrust magnetic bearing. As a result, a relatively compact magnetically levitating motor that provides a large output can be achieved despite the fact that the motor has the thrust magnetic bearing. This structure will enhance the effects described above.

Furthermore, in the magnetically levitating motor described above, the stator core sections and the stator side thrust bearing magnetic path section may be disposed adjacent to one another in the axial direction. As a result, a greater controlling force to control the position of the rotor in the thrust direction is obtained and thus the control in the thrust direction can be conducted quickly and stably.

With the magnetic bearing apparatus having the structure described above, a thrust magnetic bearing equipped with a favorable thrust bearing characteristic created by a voice coil motor (VCM) system in which a coil is wound about the rotational axis is formed into a compound structure with a radial magnetic bearing. As a result, the bearing apparatus can be reduced in size and its axial length can be shortened. Moreover, the control of movements in the bearing in the thrust direction can be stably conducted. As a result, highly practical magnetic bearing apparatuses can be obtained.

Also, in the magnetic bearing apparatus described above, the rotor side thrust bearing magnetic path section and the stator side thrust bearing magnetic path section may be formed from generally cylindrical members about the rotational axis as a center, and the thrust control coil is wound along an external circumferential surface of one of the generally cylindrical members. As a result, the thrust control coil can be contained in a small space. The bearing apparatus can be further reduced in size.

Furthermore, in the magnetic bearing apparatus described above, the thrust control coil may be short-circuited. As a result, a damper effect against vibrations in the thrust direction can be obtained without consuming the electrical power. Therefore, the power consumption can be further reduced.

Furthermore, in the magnetic bearing apparatus described above, the stator cores section and the stator side thrust bearing magnetic path section may be disposed adjacent to one another in the axial direction. As a result, a greater controlling force in the thrust direction is obtained and thus the control in the thrust direction can be conducted quickly and stably. Accordingly, the effects described above can be further enhanced.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A magnetically levitating motor having a rotor that is formed from a magnetic material and has a permanent magnet attached along a circumference thereof, and a stator core section having a first stator coil that generates a levitation control magnetic flux that controls levitation of the rotor in a radial direction and a second coil that generates rotational magnetic flux against the rotor, the magnetically levitating motor comprising:
a rotor side thrust bearing magnetic path section that is formed on the rotor;
a stator side thrust bearing magnetic path section that is disposed opposite in the radial direction to the rotor side thrust bearing magnetic path section that is provided on the stator;
a bias magnetic flux that forms the radial levitation control magnetic flux formed to pass a gap in the radial direction between the rotor side thrust bearing magnetic path section and the stator side thrust bearing magnetic path section; and
a thrust control coil that generates a supporting force to support the thrust bearing load, the thrust control coil being disposed in the bias magnetic flux that forms the radial levitation control magnetic flux, wherein the thrust control coil is wound about a rotational axis with respect to one of the rotor side thrust bearing magnetic path section and the stator side thrust bearing magnetic path section.

2. A magnetically levitating motor according to claim 1, wherein the rotor side thrust bearing magnetic path section and the stator side thrust bearing magnetic path section are formed from generally cylindrical members about the rotational axis as a center, and the thrust control coil is wound along an external circumferential surface of one of the generally cylindrical members.

3. A magnetically levitating motor according to claim 1, wherein the thrust control coil is short-circuited.

4. A magnetically levitating motor according to claim 1, wherein the stator core section includes two stator core sections disposed adjacent to each other along the axial direction, and a radial direction opposing section between the rotor side thrust bearing magnetic path section and the stator side thrust bearing magnetic path section is disposed between the two stator core sections.

5. A magnetically levitating motor according to claim 1, wherein the stator core section and the stator side thrust bearing magnetic path section are disposed adjacent to one another in the axial direction.

6. A magnetically levitating motor according to claim 1, wherein the rotor is an outer rotor type.

7. A magnetically levitating motor according to claim 1, wherein the rotor is an inner rotor type.

8. A magnetically levitating motor according to claim 1, further comprising a bias magnet that generates the bias magnetic flux provided on the side of the rotor, and a ring-shaped rotor magnet that generates a rotational torque provided on the side of the rotor and opposite to the stator core section.

9. A magnetically levitating motor according to claim 1, further comprising a bias magnet that generates the bias magnetic flux provided on the side of the stator, and a ring-shaped rotor magnet that generates a rotational torque provided on the side of the rotor opposite to the stator core section.

10. A magnetic bearing apparatus having a rotor that is formed from a magnetic material and has a permanent magnet attached along a circumference thereof, and a stator core section having a stator coil that generates a radial levitation control magnetic flux that controls levitation of the rotor in a radial direction, the magnetic bearing apparatus comprising:
a rotor side thrust bearing magnetic path section formed on the rotor;
a stator side thrust bearing magnetic path section that is disposed opposite in the radial direction to the rotor side thrust bearing magnetic path section is provided on the stator;
a bias magnetic flux that forms the radial levitation control magnetic flux formed to pass a gap in the radial direction between the rotor side thrust bearing magnetic path section and the stator side thrust bearing magnetic path section; and
a thrust control coil that generates a supporting force to support the thrust bearing load, the thrust control coil being disposed in the bias magnetic flux that forms the radial levitation control magnetic flux, wherein the thrust control coil is wound about a rotational axis with respect to one of the rotor side thrust bearing magnetic path section and the stator side thrust bearing magnetic path section.

11. A magnetic bearing apparatus according to claim 10, wherein the rotor side thrust bearing magnetic path section and the stator side thrust bearing magnetic path section are formed from generally cylindrical members about a rotational axis as a center, and the thrust control coil is wound along an external circumferential surface of one of the generally cylindrical members.

12. A magnetic bearing apparatus according to claim 10, wherein the thrust control coil is short-circuited.

13. A magnetic bearing apparatus according to claim 10, wherein the stator core section and the stator side thrust bearing magnetic path section are disposed adjacent to one another in the axial direction.

14. A magnetic bearing apparatus according to claim 10, wherein the rotor is an outer rotor type.

15. A magnetic bearing apparatus according to claim 10, wherein the rotor is an inner rotor type.

16. A magnetic bearing apparatus according to claim 10, further comprising a bias magnet that generates the bias magnetic flux provided on the side of the rotor.

17. A magnetic bearing apparatus according to claim 10, further comprising a bias magnet that generates the bias magnetic flux provided on the side of the stator.

18. A magnetically levitating motor comprising:
a rotor;
a stator disposed opposite to an outer circumferential surface of the rotor;
a thrust control coil disposed on the stator; and
two sets of bias magnetic fluxes arranged to pass a gap between the rotor and the thrust control coil.

19. A magnetically levitating motor according to claim 18, wherein the thrust control coil is wound about a rotational axis on the rotor and generates a supporting force to support a thrust bearing load acting on the rotor, the thrust control coil being disposed in the bias magnetic fluxes that form radial levitation control magnetic fluxes.

20. A magnetic bearing apparatus comprising:
a rotor;
a stator core disposed opposite to an outer circumferential surface of the rotor;
a thrust control coil disposed on the stator core; and
two sets of bias magnetic fluxes arranged to pass a gap between the rotor and the thrust control coil.

21. A magnetic bearing apparatus according to claim 20, wherein the thrust control coil is wound about a rotational axis on the rotor and generates a supporting force to support a thrust bearing load acting on the rotor, the thrust control coil being disposed in the bias magnetic fluxes that form radial levitation control magnetic fluxes.
